(19) United States
(12) Patent Application Publication
(10) Pub. No.: US 2005/0148306 A1
(43) Pub. Date: Jul. 7, 2005

(54) Predictive method and apparatus for antenna selection in a wireless communication system

(76) Inventor: Gerrit Willem Hiddink, Utrecht (NL)

Correspondence Address: Ryan, Mason & Lewis, LLP;Suite 205, 1300 Post Road, Fairfield, CT, 06824, US

(21) Appl. No.: 10/751,376

(22) Filed: Jan. 5, 2004

(51) Int. Cl. H04B 7/00

(52) U.S. Cl. 455/101; 455/277.2

(57) ABSTRACT

A predictive method and apparatus are disclosed for selecting an antenna to use in a multi-antenna wireless device. A predictive antenna selector predicts the best antenna (for both receiving and transmitting signals) based on the signal quality of the antenna for prior received frames. The quality of each antenna is evaluated, for example, in a random order, round robin fashion or according to some equal or weighted schedule. The signal quality can be evaluated for a given antenna during a preamble portion of a frame or for any frame up to an entire frame duration. A given antenna can be removed from the signal quality evaluation (for example, to a bad antenna list) if the given antenna fails to satisfy one or more predefined criteria, such as whether a signal quality of a given antenna is below a signal quality of a remainder of the plurality of antennas by a predefined amount. The signal quality of antennas on the bad antenna list can be reevaluated to determine when to return a removed antenna to the plurality of antennas that are evaluated.

### FIELD OF THE INVENTION

The present invention relates generally to antenna diversity in wireless communication systems, and more particularly, to predictive techniques for selecting an antenna in such a wireless communication system.

### BACKGROUND OF THE INVENTION

In a wireless communication system, especially in an indoor environment, multipath fading is caused by reflections of the wireless signal interfering with each other at the receiver antenna, causing a degradation in the signal quality. The reflections may be caused, for example, by various objects, such as walls, cabinets, doors or ceilings. These fading effects vary greatly with the position of the antenna. Thus, moving the antenna a small distance can make a significant difference in the signal quality. To overcome the problem of multipath fading, many wireless communications products employ antenna diversity techniques using two or more antennas. If one antenna has a poor signal quality due to a deep fade, then one of the other antennas may still provide a good signal quality.

Techniques have been proposed or suggested for selecting a given antenna to use. One class of solutions selects the best receive antenna based on the signal quality of a preamble or trailer of the transmission, and switches to the selected antenna while the preamble is still in progress so that the actual data frame is received on the antenna with the highest signal quality. This class of solutions tests the signal strength of all antennas during the reception of the preamble (the part of the signal that is used to train or synchronize the receiver) of the actual frame, and the receiver is configured to use the best antenna before the data arrives. An example of a communications protocol where multiple antennas can be tested during the preamble are the Complementary Code Keying (CCK) and Binary Phase Shift Keying (BPSK) modulated frames that are described in the IEEE 802.11 standard, described in International Standard ISO/IEC 8802-11: Wireless LAN Medium Access Control (MAC) and Physical Layer (PHY) specifications, where the preamble is 192 or 96 microseconds (which is generally sufficient to measure the signal quality of at least two antennas). The receiver generally cannot switch to a different antenna once the actual header or payload data is being received, because switching the antenna would cause data errors.

In many wireless implementations, however, the duration of the preamble does not allow multiple antennas to be tested, because the preamble is too short, or the time to perform a test on an antenna is too long. For example, the proposed IEEE 802.11a and 802.11g standards provide preambles of only 20 microseconds. The proposed IEEE 802.11a and 802.11g standards are described, respectively, for example, in IEEE, “Supplement to Standard for Telecommunications and Information Exchange Between Systems—LAN/MAN Specific Requirements—Part 11: Wireless MAC and PHY Specifications: Higher Speed Physical Layer, IEEE Std 802.11a; and IEEE, “Supplement to Standard for Telecommunications and Information Exchange Between Systems—LAN/MAN Specific Requirements—Part 11: Wireless MAC and PHY Specifications: Further High Data Rate Extension in the 2.4 GHz Band,” IEEE Std 802.11g/D6.2, January 2003, each incorporated by reference herein. A need exists for improved predictive methods and apparatus for selecting an antenna to use in a multi-antenna wireless device.

### SUMMARY OF THE INVENTION

Generally, a predictive method and apparatus are disclosed for selecting an antenna to use in a multi-antenna wireless device. A predictive antenna selector predicts the best antenna (for both receiving and transmitting signals) based on the signal quality of the antenna for prior received frames. The quality of each antenna is evaluated, for example, in a random order, round robin fashion or according to some equal or weighted schedule. The signal quality can be evaluated for a given antenna during a preamble portion of a frame or for any frame up to an entire frame duration.

According to another aspect of the invention, a given antenna is removed from the signal quality evaluation (for example, to a bad antenna list) if the given antenna fails to satisfy one or more predefined criteria, such as whether a signal quality of a given antenna is below a signal quality of a remainder of the plurality of antennas by a predefined amount. The signal quality of antennas on the bad antenna list can be reevaluated to determine when to return a removed antenna to the plurality of antennas that are evaluated.

A more complete understanding of the present invention, as well as further features and advantages of the present invention, will be obtained by reference to the following detailed description and drawings.

### BRIEF DESCRIPTION OF THE DRAWINGS

FIG. 1 illustrates a wireless network environment in which the present invention can operate;

FIG. 2 is a schematic block diagram of an exemplary station of FIG. 1 incorporating features of the present invention;

FIG. 3 illustrates a frame of data according to an exemplary IEEE 802.11a or 802.11g wireless protocol;

FIG. 4 is a flow chart describing an exemplary implementation of a predictive antenna selection process of FIG. 2 incorporating features of the present invention;

FIG. 5 is a sample record of an antenna quality table used by the predictive antenna selection process of FIG. 4; and

FIGS. 6A and 6B, collectively, illustrate an exemplary pseudo-code implementation of the predictive antenna selection process of FIG. 4.

### DETAILED DESCRIPTION

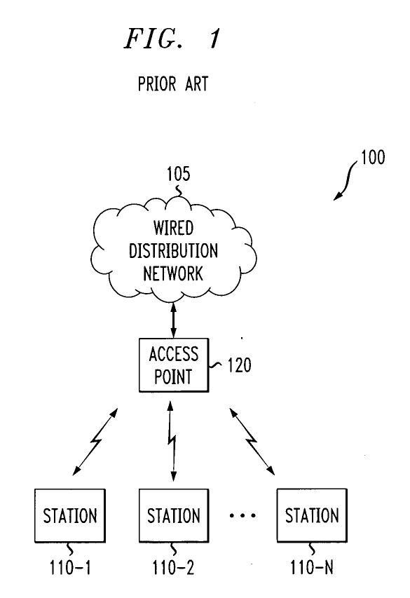

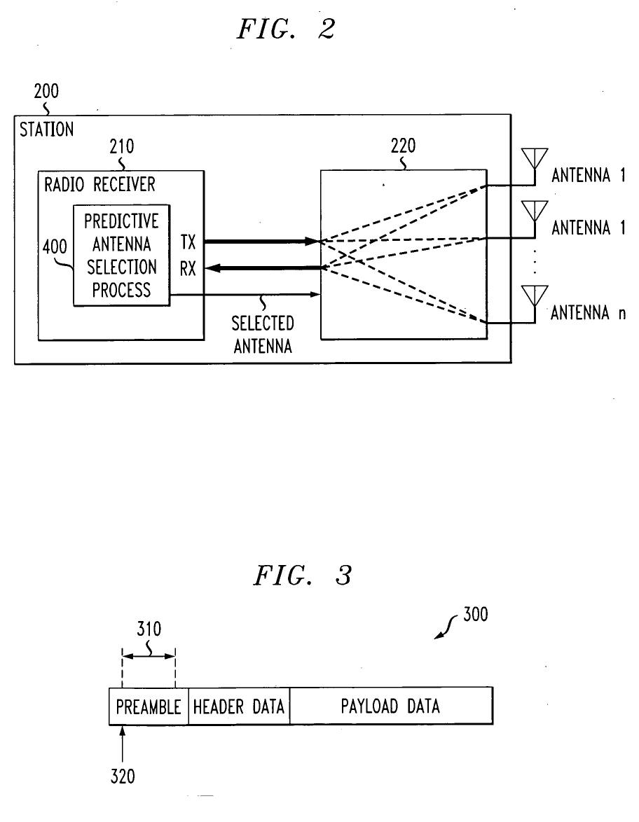

FIG. 1 illustrates a wireless network environment 100 in which the present invention can operate. The wireless network environment 100 may be, for example, a wireless LAN or a portion thereof. As shown in FIG. 1, a number of stations 200-1 through 200-N, collectively referred to as stations 200 and discussed below in conjunction with FIG. 2, communicate over one or more wireless channels in the wireless digital communication system 100. An access point 120 is typically connected to a wired distribution network 105 with other access points (not shown). The access point 120 typically provides control and security functions, in a known manner. In addition, the access point 120 acts as a central node through which all traffic is relayed so that the stations 200 can rely on the fact that transmissions will originate from the access point 120.

For example, in the IEEE 802.11 protocol, the access point 120 is the central node, and a station 200 or “client node” that is associated with the access point 120 can predict from what source the next relevant frame will originate. The IEEE 802.11 protocol specifies that all communications are relayed via the access point 120, so each transmission that is of interest (other access points 120 may be active on the same radio channel in the IEEE 802.11 protocol) is from the access point 120 the stations 200 is associated with. An example of such a communications protocol is the Enhanced Service Set (ESS) mode of the IEEE 802.11 protocol, in which stations 200 are associated with an access point 120 that relays all communication.

The wireless network environment 100 may be implemented, for example, in accordance with the IEEE 802.11 Standard, as described, for example, in “Wireless LAN Medium Access Control (MAC) and Physical Layer (PHY) Specifications (1999); IEEE Std 802.11a; High-speed Physical Layer in the 5 GHz band; 1999; IEEE Std 802.11b; Higher-Speed Physical Layer Extension in the 2.4 GHz Band; 1999; or IEEE Std 802.11g/D1.1; Further Higher-Speed Physical Layer Extension in the 2.4 GHz Band; Draft version; January 200, each incorporated by reference herein.

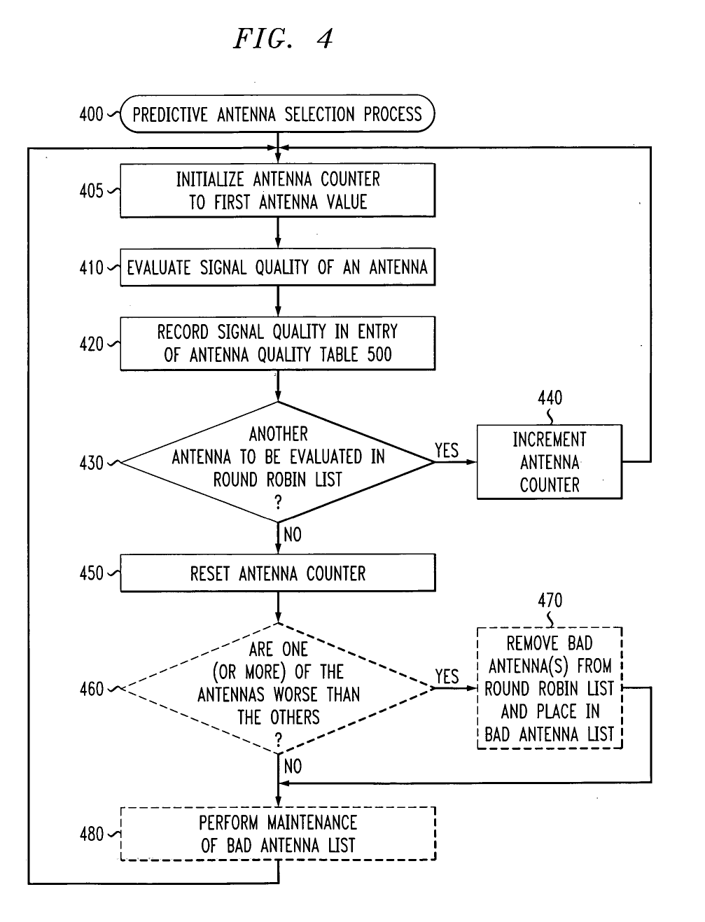

FIG. 2 is a schematic block diagram of an exemplary station 200 incorporating features of the present invention. The stations 200 may each be embodied, for example, as personal computer devices, or any device having a wireless communication capability, such as a cellular telephone, personal digital assistant or pager, as modified herein to provide the features and functions of the present invention. As shown in FIG. 2, an exemplary station 200 includes a radio receiver 210, a switchbox 220, and several antennas ANT 1 through ANT n, in a known manner. The switchbox 220 allows any antenna ANT-i to be used either as a transmit antenna or as a receive antenna. The radio receiver 210 includes a predictive antenna selection process 400, discussed below in conjunction with FIG. 4. The predictive antenna selection process 400 predicts the best antenna (for both receiving and transmitting signals) based on the signal quality of the antenna for prior received frames. In particular, the predictive antenna selection process 400 incorporates features of the present invention to evaluate the quality of each antenna, for example, in a random order, round robin fashion or according to some equal or weighted schedule.

As previously indicated, the duration of the preamble in many wireless implementations does not allow multiple antennas to be tested, because the preamble is too short, or the time to perform a test on an antenna is too long. FIG. 3 illustrates a frame 300 of data according to an exemplary IEEE 802.11a or 802.11g wireless protocol, where the preamble is only 20 microseconds. As shown in FIG. 3, a frame 300 includes a preamble, a header and a payload. The time 310 required to measure the signal quality of a given antenna does not allow the receiver to measure multiple antennas. Thus, at a time 320, a receiver detects transmission on a first antenna and starts to measure signal quality, but there is no additional time to measure the signal quality of further antennas.

FIG. 4 is a flow chart describing an exemplary implementation of a predictive antenna selection process 400 incorporating features of the present invention. The predictive antenna selection process 400 evaluates the signal quality of each antenna, for example, in a random order, round robin fashion or according to some equal or weighted schedule, and selects the best antenna to receive frames. While the predictive antenna selection process 400 is illustrated in the context of an Enhanced Service Set (ESS) mode of the IEEE 802.11 protocol, where stations 200 are associated with an access point 120 that relays all communications, the present invention applies in any context where a given station 200 can anticipate that transmissions will originate from a given node. Thus, a signaling mechanism can be established among the various stations 200 in an ad-hoc or peer-to-peer mode (such as the Independent Basic Service Set (IBSS) mode of the IEEE 802.11 protocol, where all stations can send directed frames to each other) so that a given station can anticipate the node from which transmissions will originate. In other words, the communications protocol can provide a signaling mechanism for the access point 120 and station 200 (or two stations) to come to an agreement on what diversity configuration to use (i.e., which device will not use any antenna diversity).

Generally, the access point 120 (or a station 200 configured to act as a central node), will configure its radio receiver 210 not to use any diversity, i.e., the access point 120 transmits and receives on the same antenna. The stations 200 employ the predictive antenna selection process 400 to predict the best antenna for communicating with the access point 120, and to configure their receiver to use the best antenna for the consecutive reception(s) and transmission(s).

As discussed hereinafter, the exemplary predictive antenna selection process 400 configures the station 200 to use the receive antennas in a round-robin fashion. For example, if a station 200 has three antennas, then the station 200 will successively use each antenna for reception of a frame. After using all three antennas, the station 200 goes back to the first antenna and repeats the cycle.

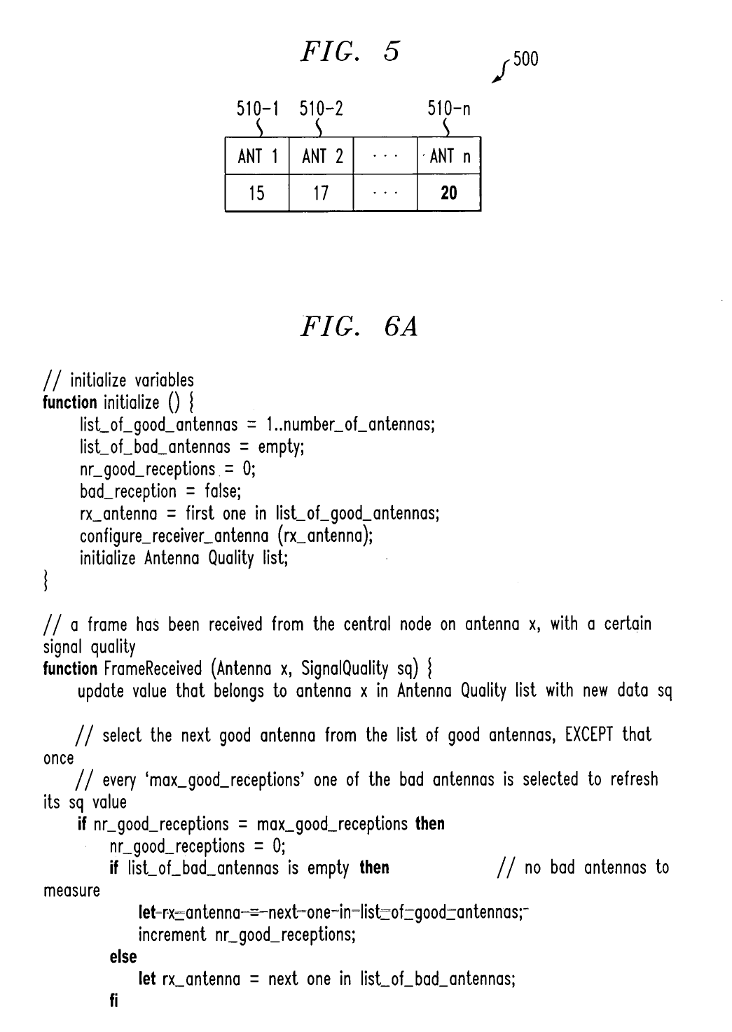

Thus, the predictive antenna selection process 400 initializes an antenna counter to the first antenna value during step 405 and evaluates the signal quality of an antenna during step 410. The signal quality of an antenna can be determined, for example, by measuring the amount of RF energy that is captured by the antenna, possibly after some amplification steps. The signal quality measurement can be instantaneous, or an accumulated amount of energy during a certain time interval. In a further variation, an averaging algorithm can be employed to filter out fluctuations and to obtain a stable indication. The evaluation of a given antenna can be performed during the preample portion or any portion of a frame, and can last up to a full frame duration. The signal quality is recorded during step 420 in an appropriate entry of an antenna quality table 500, discussed below in conjunction with FIG. 5. Generally, the antenna quality table 500 maintains one quality value for each antenna, characterizing the signal quality of the reception for the corresponding antenna.

A test is performed during step 430 to determine if there is another antenna to be evaluated in a round robin (good) antenna list. If it is determined during step 430 that there is another antenna to be evaluated in the round robin antenna list, then the antenna counter is incremented to the next antenna identifier during step 440 before program control returns to step 410 to evaluate the next antenna. If, however, it is determined during step 430 that there is not another antenna to be evaluated in the round robin antenna list, then the antenna counter is reset during step 450 before program control returns to step 410 to evaluate the first antenna.

As shown in FIG. 4, a further test is optionally performed during step 460 to determine if one (or more) of the antennas becomes much worse than the others (by a particular margin that depends on the specifics of the radio environment). If one (or more) of the antennas becomes much worse than the others, then the node will no longer include this antenna in its round-robin schedule, but instead it will be put in a “bad antenna” list during step 470. The particular criteria for an antenna to be placed on the bad antenna list depends on the radio environment, and more particularly on the depth of fades that can be expected, as would be apparent to a person of ordinary skill in the art. For example, if a fade is 10 dB deep, then an appropriate difference between “good” and “bad” antennas may be on the order of 8 dB. If a fade is 40 dB deep, then an appropriate difference between “good” and “bad” antennas may be on the order of 35 dB. The station 200 will only “probe” a reception on one of the bad antennas once every n receptions to update the signal quality values. Here, n also depends on the specific details of the radio environment and the communication protocol being used. Once the signal quality of the antenna is above the specified margin again, the antenna is put back into the round robin list. To avoid a bouncing effect, a hysteresis technique can be used. Such maintenance of the bad antenna list can be performed during step 480.

Thus, whenever a station 200 has received a frame from the access point 120 on a given antenna x, then the station 200 will register the signal quality of the transmission in the antenna quality table 500, at the location corresponding to antenna x. Thereafter, when the station 200 wants to transmit a frame to the access point 120, then the station 200 performs a lookup in the antenna quality table 500 to identify the antenna that previously resulted in the highest signal quality, and the station 200 will configure its transmitter to use that antenna for the transmission.

As previously indicated, the signal quality of each antenna is recorded by a station 200 in a corresponding entry of an antenna quality table 500, shown in FIG. 5. The antenna quality table 500 includes a plurality of entries 510-1 through 510-n, for recording a quality value for each of the n antennas. The stored quality value characterizes the signal quality of the reception for the corresponding antenna.

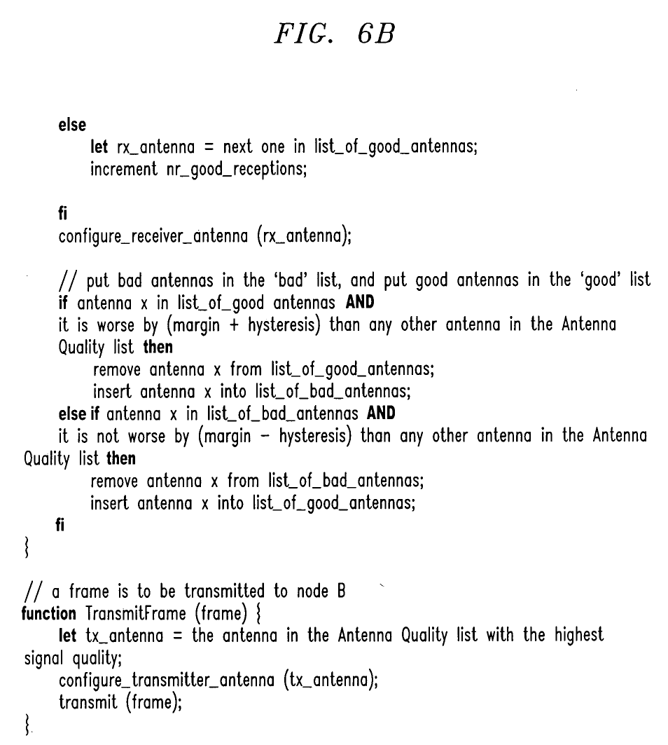

FIGS. 6A and 6B, collectively, illustrate an exemplary pseudo-code implementation of the predictive antenna selection process 400 of FIG. 4. In the pseudo-code 600 shown in FIGS. 6A and 6B, the number of antennas used in the system is stored in a variable “number_of_antennas;” the command “configure_transmitter_antenna (a)” configures antenna ‘a’ for the next transmission; the command “configure_receiver_antenna (a)” configures antenna ‘a’ for the next reception; the command “transmit (Frame)” actually transmits the frame; the variable “max_good_receptions” is a constant that indicates how many receptions on a ‘good’ antenna should be done before doing a measurement on a ‘bad’ antenna; and the command “selecting antennas from the list” includes beginning from the start of the list if it has been traversed completely.

It is to be understood that the embodiments and variations shown and described herein are merely illustrative of the principles of this invention and that various modifications may be implemented by those skilled in the art without departing from the scope and spirit of the invention.

1. A wireless communication device, comprising:
a plurality of antennas; and
a predictive antenna selector that evaluates a signal quality of each of said plurality of antennas and selects an antenna to communicate one or more frames based on said signal quality evaluation.

2. The wireless communication device of claim 1, wherein said predictive antenna selector evaluates a signal quality of each of said plurality of antennas during a preamble portion of a frame.

3. The wireless communication device of claim 1, wherein said predictive antenna selector evaluates a signal quality of each of said plurality of antennas for up to an entire frame duration.

4. The wireless communication device of claim 1, wherein said predictive antenna selector removes a given antenna from said evaluation if said given antenna fails to satisfy predefined criteria.

5. The wireless communication device of claim 4, wherein said predefined criteria evaluates whether a signal quality of a given antenna is below a signal quality of a remainder of said plurality of antennas by a predefined amount.

6. The wireless communication device of claim 4, wherein a signal quality of said removed antenna is subsequently evaluated to determine when to return said removed antenna to said plurality of antennas that are evaluated.

7. The wireless communication device of claim 1, wherein said signal quality of said plurality of antennas is recorded in a table.

8. The wireless communication device of claim 1, wherein said predictive antenna selector evaluates said signal quality of each of said plurality of antennas in a round robin manner.

9. The wireless communication device of claim 1, wherein said predictive antenna selector evaluates said signal quality of each of said plurality of antennas in a random order.

10. The wireless communication device of claim 1, wherein said predictive antenna selector evaluates said signal quality of each of said plurality of antennas based on a schedule.

11. The wireless communication device of claim 1, wherein said device is implemented in accordance with an IEEE 802.11 Standard.

12. The wireless communication device of claim 1, wherein said predictive antenna selector selects an antenna based on a signal quality evaluation of at least a portion of one prior frame.

13. A method for wireless communication on one of a plurality of antennas, comprising the steps of:
evaluating a signal quality of each of said plurality of antennas; and
selecting an antenna to communicate one or more frames based on said signal quality evaluation for at least one prior frame.

14. The method of claim 13, wherein said evaluating step evaluates a signal quality of each of said plurality of antennas during a preamble portion of a frame.

15. The method of claim 13, wherein said evaluating step evaluates a signal quality of each of said plurality of antennas for up to an entire frame duration.

16. The method of claim 13, wherein said selecting step removes a given antenna from said evaluation if said given antenna fails to satisfy predefined criteria.

17. The method of claim 16, wherein said predefined criteria evaluates whether a signal quality of a given antenna is below a signal quality of a remainder of said plurality of antennas by a predefined amount.

18. The method of claim 13, further comprising the step of recording said signal quality of said plurality of antennas in a table.

19. The method of claim 13, wherein said evaluating step evaluates said signal quality of each of said plurality of antennas in a round robin manner.

20. The method of claim 13, wherein said evaluating step evaluates said signal quality of each of said plurality of antennas in a random order.

21. The method of claim 13, wherein said evaluating step evaluates said signal quality of each of said plurality of antennas based on a schedule.

22. The method of claim 13, wherein said method is implemented in accordance with an IEEE 802.11 Standard.

23. A predictive antenna selector for use in a wireless communication device, comprising:
means for evaluating a signal quality of a plurality of antennas; and
means for selecting an antenna to communicate one or more frames based on said signal quality evaluation for at least one prior frame.

24. The predictive antenna selector of claim 23, wherein a given antenna is removed from said evaluation if said given antenna fails to satisfy predefined criteria.

25. The predictive antenna selector of claim 24, wherein said predefined criteria evaluates whether a signal quality of a given antenna is below a signal quality of a remainder of said plurality of antennas by a predefined amount.
